(19) United States
(12) Patent Application Publication
(10) Pub. No.: US 2010/0276198 A1
(43) Pub. Date: Nov. 4, 2010

(54) VARIABLE FORCE/VARIABLE FREQUENCY SONIC DRILL HEAD

(75) Inventor: Trevor Lyndon Light, Sandy, UT (US)

Correspondence Address: Workman Nydegger;1000 Eagle Gate Tower, 60 East South Temple, Salt Lake City, UT, 84111, US

(73) Assignee: LONGYEAR TM, INC., South Jordan, UT (US)

(21) Appl. No.: 12/768,390

(22) Filed: Apr. 27, 2010

Related U.S. Application Data
(60) Provisional application No. 61/173,905, filed on Apr. 29, 2009.

(51) Int. Cl. E21B 7/24; F16H 33/20

(52) U.S. Cl. 175/55; 74/61

(57) ABSTRACT

An oscillator assembly includes a first eccentrically weighted rotor having a first eccentric weight configured to rotate about an axis, a second eccentrically weighted rotor having a second eccentric weight configured to rotate about the axis. Rotation of the first eccentrically weighted rotor is coupled to rotation of the second eccentrically weighted rotor. An actuator is configured to vary an angular separation between the first eccentric weight and the second eccentric weight.

### CROSS-REFERENCE TO RELATED APPLICATIONS

The present application claims the benefit of U.S. Provisional Application No. 61/173,905 filed Apr. 29, 2009 and entitled “Variable Force/Variable Frequency Sonic Drill Head”, the disclosure of which is hereby incorporated by reference in its entirety.

### BACKGROUND OF THE INVENTION

1. The Field of the Invention

The present invention relates to drill heads and to drill heads configured to generate oscillating vibratory forces.

2. The Relevant Technology

Sonic head assemblies are often used to vibrate a drill string and the attached coring barrel and drill bit at high frequency to allow the drill bit and core barrel to penetrate through the formation as the drill bit rotates. Accordingly, some drilling systems include a drill head assembly that includes both an oscillator to provide the high frequency input and a motor driven gearbox to rotate the drill string. The sonic head includes pairs of eccentrically weighted rotors that are rotated to generate oscillating or vibratory forces. The eccentrically weighted rotors are coupled to a spindle. The spindle can in turn be coupled to a drill rod such that turning the eccentrically weighted rotors transmit a vibratory force from the spindle to the drill rod.

The force generated by the sonic head depends, at least in part, on the eccentric weight of the rotors, the eccentric radius of the eccentric weight of the rotors, and the rotational speed of the eccentric rotors. In most systems, the eccentric weight and eccentric radius of the rotors are fixed. Accordingly, in order to vary the vibratory forces generated by a given sonic head, the rotational speed of the eccentric rotors is varied. Each system has a natural harmonic frequency at which the vibratory forces resonate through the system resulting in extremely large forces. As the sonic head spins the rotors up to the desired rotational speed to apply a selected vibratory force, the system often passes through one or more of the harmonic frequencies. The forces generated at these harmonic frequencies are often large enough to damage the sonic head and other parts of the drilling system. The maximum force output of the oscillator can thus be dictated by the speed of rotation, which can be held below a speed corresponding to a harmonic frequency.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

An oscillator assembly includes a first eccentrically weighted rotor having a first eccentric weight configured to rotate about an axis, a second eccentrically weighted rotor having a second eccentric weight configured to rotate about the axis. Rotation of the first eccentrically weighted rotor is coupled to rotation of the second eccentrically weighted rotor. An actuator is configured to vary an angular separation between the first eccentric weight and the second eccentric weight.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

To further clarify the above and other advantages and features of the present invention, a more particular description of the invention will be rendered by reference to specific examples which are illustrated in the appended drawings. It is appreciated that these drawings depict only typical examples of the invention and are therefore not to be considered limiting of its scope. Examples will be described and explained with additional specificity and detail through the use of the accompanying drawings in which:

FIG. 1A illustrates a drilling system according to one example;

FIG. 1B illustrates a drilling head that includes a sonic drill head and a rotary head assembly according to one example;

FIG. 2A illustrates an assembled view of the example sonic drill head;

FIG. 2B-2C illustrate cross sectional views of an example oscillator assembly of the exemplary sonic drill head of FIG. 2A taken along section 2-2;

FIG. 2D illustrates a perspective view of a coupling shaft according to one example;

FIGS. 2E-2F illustrate cross-sectional view of the oscillator assembly of FIGS. 2B-2C;

FIGS. 3A-3D illustrate a sonic drill head with eccentric weights in eccentrically weighted rotors at various angular separations; and

FIG. 4 illustrates an actuation assembly according to one example.

Together with the following description, the figures demonstrate non-limiting features of exemplary devices and methods. The thickness and configuration of components can be exaggerated in the figures for clarity. The same reference numerals in different drawings represent similar, though not necessarily identical, elements.

### DETAILED DESCRIPTION OF THE PREFERRED EMBODIMENTS

Devices, systems, and methods are provided herein for sonic drilling that include at least one variable force/variable frequency oscillator assembly. In at least one example, such an oscillator assembly includes a first eccentrically weighted rotor with a first eccentric weight, a second eccentrically weighted rotor with a second eccentric weight, a coupling shaft, an actuator, and a motor. The motor can be configured to rotate the coupling shaft. The coupling shaft includes a straight splined portion associated with the first eccentrically weighted rotor and a helical portion associated with the second eccentrically weighted rotor.

The actuator can move the coupling shaft, such as through axial translation, to cause relative angular movement between the first and second rotors through a range of 180 degrees. Varying the angular separation between the two rotors can vary the centrifugal forces generated by rotation of the oscillator assembly at a given rotational speed or frequency. Accordingly, force can be varied independently of frequency, which can allow a drilling system to apply varying forces at a given frequency and given forces at varying frequencies while avoiding undesirable frequencies, such as natural or harmonic frequencies.

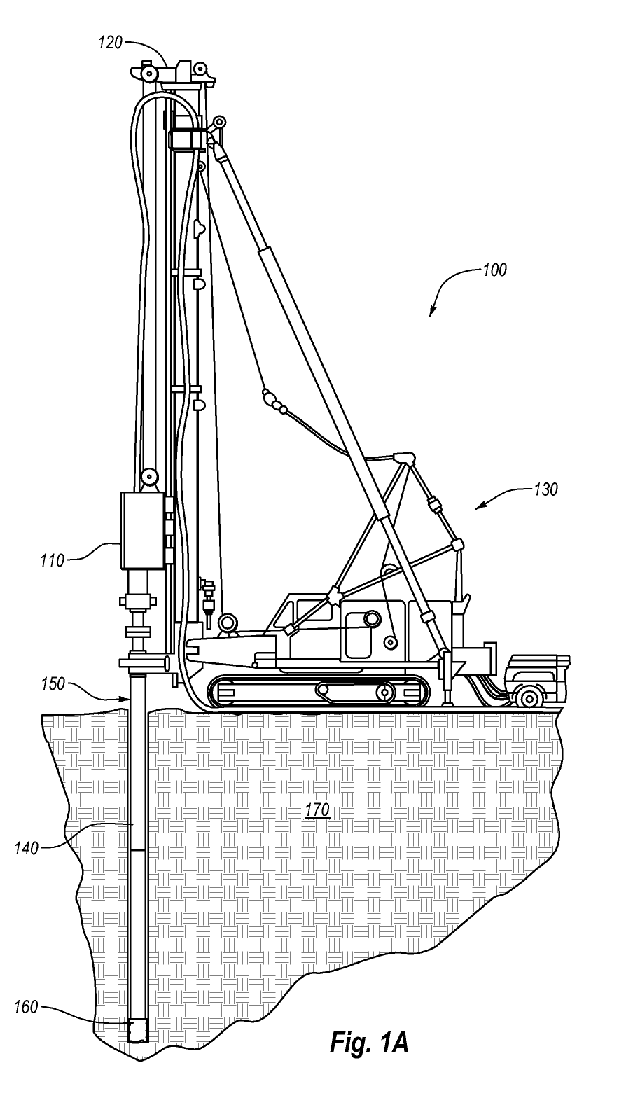

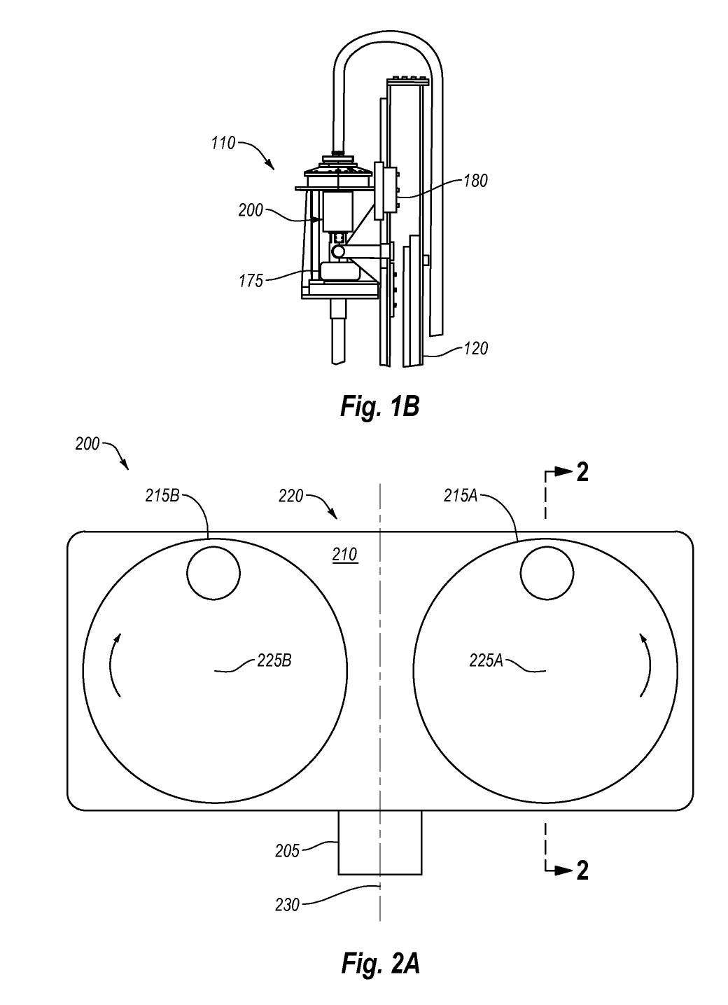

FIG. 1A illustrates a drilling system 100 that includes a drill head assembly 110. The drill head assembly 110 can be coupled to a mast 120 that in turn is coupled to a drill rig 130. The drill head assembly 110 is configured to have a drill rod 140 coupled thereto. The drill rod 140 can in turn couple with additional drill rods to form a drill string 150. In turn, the drill string 150 can be coupled to a drill bit 160 configured to interface with the material to be drilled, such as a formation 170.

In at least one example, the drill head assembly 110 is configured to rotate the drill string 150 at varying rates as desired during the drilling process. Further, the drill head assembly 110 can be configured to translate relative to the mast 120 to apply an axial force to the drill head assembly 110 to urge the drill bit 160 into the formation 170. The drill head assembly 110 can also generate oscillating forces that are transmitted to the drill rod 140. These forces are then transmitted from the drill rod 140 through the drill string 150 to the drill bit 160.

FIG. 1B illustrates the drill head assembly 110 in more detail. As illustrated in FIG. 1B, the drill head assembly 110 can include a rotary portion 175 mounted to a sled 180. The drill head assembly 110 can further include a sonic drill head 200 mounted to the sled 180.

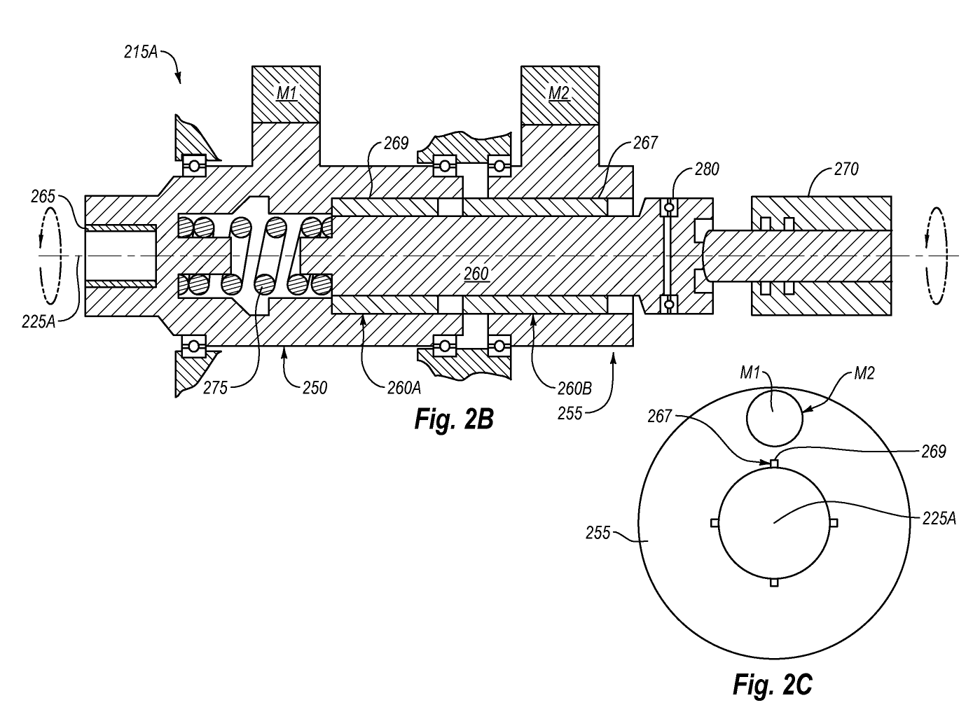

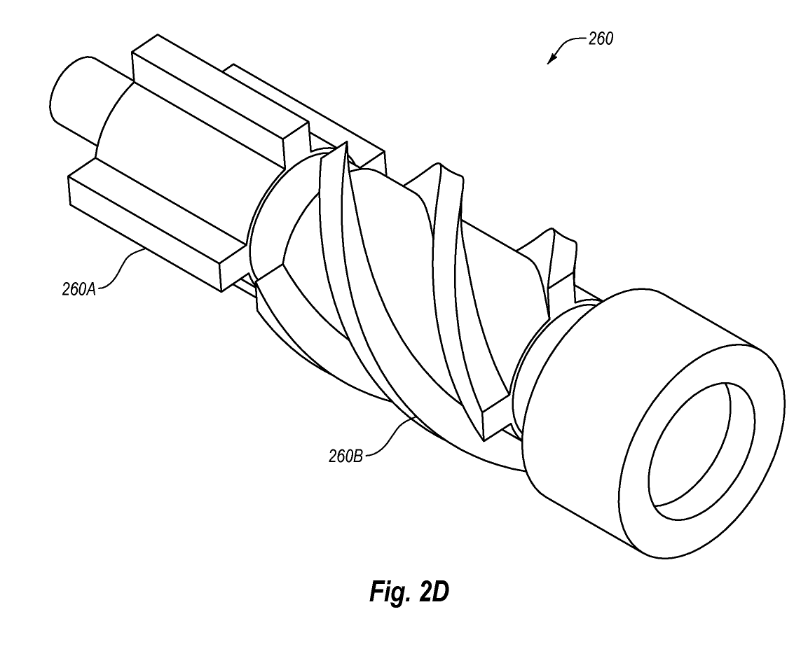

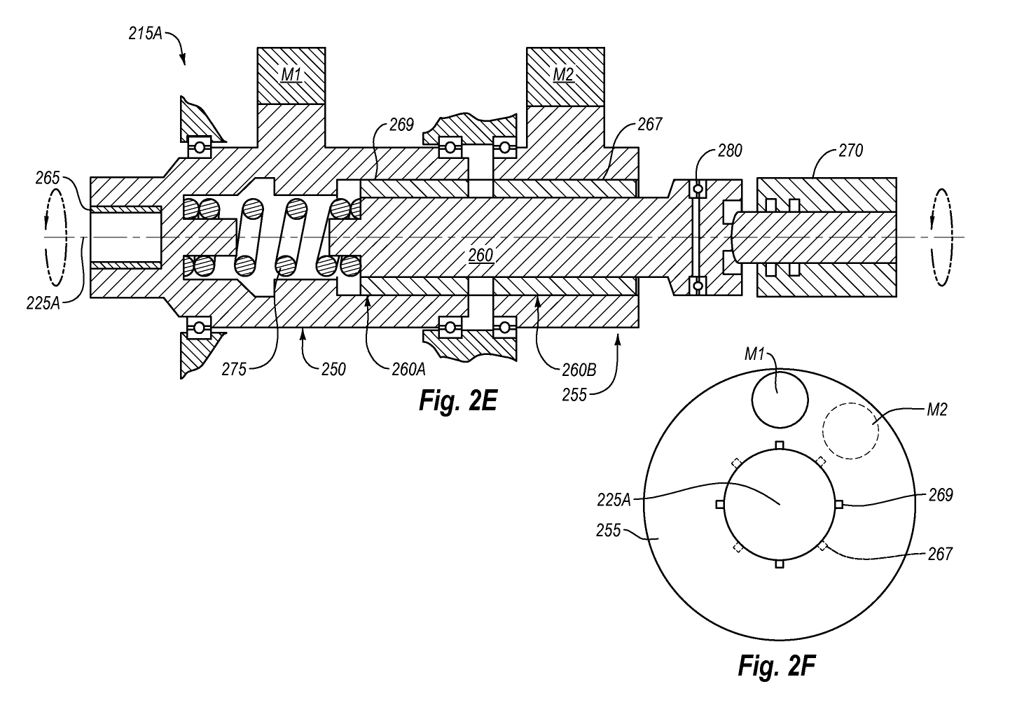

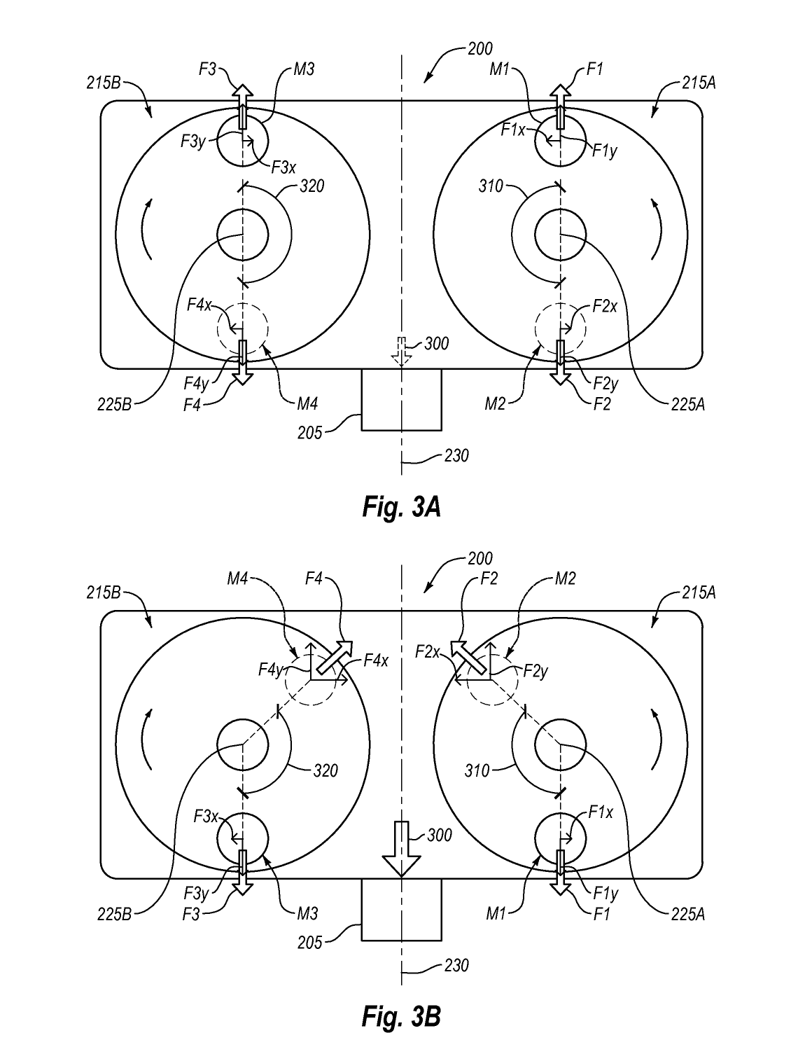

FIG. 2A illustrates an isolated elevation view of the sonic drill head 200 in more detail. The sonic drill head 200 includes an oscillator 210 having first and second opposing oscillator assemblies 215A, 215B positioned within a housing 220. The oscillator assemblies 215A, 215B are configured to rotate about axes 225A, 225B to generate cyclical, oscillating centrifugal forces. Centrifugal forces due to rotation of the oscillator assemblies 215A, 215B can be resolved into a first component acting parallel to a drive shaft axis 230 and a second component acting transverse to the drive shaft axis 230. In at least one example, a force acting parallel to the drive shaft axis 230 can be described as acting in the transmission direction.

In at least one example, the oscillator assemblies 215A, 215B rotate at identical speeds but opposite directions. Further, the oscillator assemblies 215A, 215B can be oriented such that as they rotate, the second component of the centrifugal forces acting transverse to the drive shaft axis 230 cancel each other out while the first components acting parallel to the drive shaft axis 230 combine, resulting in axial, vibratory forces.

These oscillating vibratory forces are transmitted to the housing 220. A drive shaft 205 may be coupled to the oscillator housing 220 in such a manner that the centrifugal forces described above can be transmitted from the oscillator housing 220 to the drive shaft 205. The drive shaft 205 then transmits the forces to other components, such as a drill rod.

As shown in FIG. 2B, first oscillator assembly 215A includes a plurality of eccentrically weighted rotors 250, 255 each having eccentric weights M1, M2 that rotate about a common axis 225A. The second eccentrically weighted rotor 215B has a similar configuration such that the description of the first eccentrically weighted rotor 215A may be equally applicable to the second eccentrically weighted rotor 215B.

An angular separation of the eccentric weights M1, M2 relative to each other can be varied as desired. Varying the angular separation of the eccentric weights M1, M2 within the first oscillator assembly 215A can allow the sonic drill head 200 (FIG. 2A) to vary the force generated by the first oscillator assembly 215A as it rotates at a given velocity. In particular, an angular separation of 180 degrees between the eccentric weights M1, M2 causes the force generated by rotation of one eccentrically weighted rotor 250 to balance out the force generated by the rotation of the other eccentrically weighted rotor 255. Similarly, angular alignment of the eccentrically weighted rotors 250, 255 can result in a summation of the forces generated by eccentrically weighted rotors 250, 255. Adjusting the angular separation between the eccentric weights M1, M2 can therefore vary the resulting force generated by the rotation of eccentrically weighted rotors 250, 255. In at least one example, the eccentrically weighted rotors 250, 255 may be rotated by a single rotational output while in other examples the eccentrically weighted rotors 250, 255 may be rotated by distinct, separate rotary outputs. For ease of reference, a single rotational output will be described below.

FIGS. 2B-2C and FIGS. 2E-2F illustrate a cross-sectional view of the oscillator assembly 215A taken along section 2-2 of FIG. 2A. While oscillator assembly 215A is shown, it will be appreciated that the discussion of the oscillator assembly 215A can be applicable to the other oscillator assembly 215B rotating in the opposite direction. Further, while two opposing oscillator assemblies 215A, 215B are shown in FIG. 2A, it will be appreciated that any number of eccentrically weighted rotors can be positioned within each oscillator assembly and that any number of oscillator assemblies can be combined as desired. The configuration of the example first oscillator assembly 215A will now be described in more detail.

FIG. 2B, illustrates a cross-sectional view of the first oscillator assembly 215A according to one example. Locations and sizes of various components may have been exaggerated for ease of illustration. As shown in FIG. 2B, a coupling shaft 260 couples the first eccentrically weighted rotor 250 and the second eccentrically weighted rotor 255 that rotate about the common axis 225A. In the example illustrated in FIGS. 2B-2D, the coupling shaft 260 includes a straight splined portion 260A configured to receive a rotational input from the first eccentrically weighted rotor 250 and to transmit the rotational input to the second eccentrically weighted rotor 255 by a helically splined portion 260B. Translation of the coupling shaft 260 parallel to the axis 225A varies the angular separation between the eccentric weights M1, M2, as will be discussed in more detail below.

A drive motor 265 can be coupled to the first eccentrically weighted rotor 250 to provide rotation. The coupling shaft 260 is coupled to the first eccentrically weighted rotor 250 in such a manner as to allow the coupling shaft 260 to translate relative to the first eccentrically weighted rotor 250 along the axis 225A. Further, the coupling shaft 260 may be configured to remain engaged with the first eccentrically weighted rotor 250 in such a manner as to allow the coupling shaft 260 to drive the first eccentrically weighted rotor 250. Accordingly, the straight-splined portion 260A may include straight splines 269 that engage similarly shaped recesses defined in the first eccentrically weighted rotor 250. Such a configuration allows the coupling shaft 260 to translate relative to the first eccentrically weighted rotor while receiving a rotational input from the first eccentrically rotor 250.

As introduced, the coupling shaft 260 is configured to transmit the rotation input to the second eccentrically weighted rotor 255. In at least one example, the coupling shaft 260 can be configured to engage various portions of the second eccentrically weighted rotor 255. In particular, the helical portion 260B (FIG. 2B) includes individual splines 267 that are helically wound about the coupling shaft 265. At each axial position of the helical portion 260B the helical splines 267 are positioned at varying angular positions. For ease of reference, these angular positions can be described as varying relative to the straight splines 269 parallel to the axis 225A. As a result, as the helical splines 267 move further away from the straight splined portion 260A, the angular separation between the helical splines 267 and the corresponding straight splines 269 also increases.

FIG. 2C illustrates the engagement between the helical portion 260B and the second eccentric weight M2 in which other components have been removed for clarity. In particular, FIG. 2C illustrates the helical splines 267 engaged with the second eccentric weight M2 at an axial position on the helical portion 260B in which the second eccentric weight M2 is aligned relative to the first eccentric weight M1. At this axial position the helical splines 267 are also at a first angular position relative to corresponding straight splines 269. For ease of reference, the helical splines 267 at the axial position shown in FIG. 2C will be described as being aligned relative to the straight splines 269.

Accordingly, the helical splines 267 are shown aligned relative to straight splines 269, such that straight splines 269 are hidden by the helical splines 267 in contact with the second eccentrically weighted rotor 255 and in which the first eccentric weight M1 is also aligned and therefore covered by the second eccentric weight M2.

As shown in FIG. 2B the coupling shaft 260 can translate along the axis 225A to vary the angular position of the helical splines 267 relative to the straight splines 269 and thus the angular position of the first eccentric weight M1 relative to the second eccentric weight M2. For example, the biasing member 275 exerts a force to move the helical portion 260B away from the first eccentrically weighted rotor 250. The actuator 270 acts in opposition to the biasing member 275 such that extension of the actuator 270 overcomes the force of the biasing member 275 to move the helical portion 260B toward the first eccentrically weighted rotor 250.

Accordingly, retracting the actuator 270 allows a force exerted by the biasing member 275 to move the helical portion 260B away from the first eccentrically weighted rotor 250. The actuator 270 and the biasing member 275 maintain the second eccentrically weighted rotor 255 at the selected axial position relative to the axis 225A as the coupling shaft 260 rotates. Accordingly, the actuator 270 and the biasing member 275 can cooperate to vary which part of the helical portion 260B engages the second eccentrically weighted rotor 255.

FIG. 2E illustrates the actuator 270 and the biasing member 275 cooperating to move the helical portion 260B away from the first eccentrically weighted rotor 250. As the helical portion 260B advances to the position shown in FIG. 2E, the portion of the helical splines 267 in contact with the second eccentrically weighted rotor 255 is at an angular separation relative to the corresponding straight splines 269. The angular separation between the straight splines 269 and the engaged portion of the helical splines 267 shown results in the angular separation between the first eccentric weight M1 and the second eccentric weight M2 illustrated in FIG. 2F.

Further movement of the helical portion 260B away from the first eccentrically weighted rotor 250 can further increase the angular separation while moving the helical portion 260B toward the first eccentrically weighted rotor 250 can decrease the angular separation. Accordingly, the angular separation between the first eccentric weight M1 and the second eccentric weight M2 can be varied by controlling which axial portion of the helical portion 260B engages the second eccentrically weight rotor. In at least one example, angular separation between the first eccentric weight M1 and the second eccentric weight M2 can vary between 0 or an aligned position to 180 degrees.

In the illustrated example, reference has been made to movement of the coupling shaft 260 relative to the first eccentrically weighted rotor to vary angular separation. Similarly, various angles and orientations have been described. It will be appreciated that any reference point can be selected in describing a system that includes a coupling shaft that translates axially relative to two eccentrically weighted rotors to control the angular separation between eccentric weights associated with the eccentrically weighted rotors. Further, any rate of twist, combination of twists, or other engagement profiles can be provided on the coupling shaft to allow the coupling shaft to vary angular separation between eccentric weights by varying which portion of the shaft is in contact with one or more of the eccentrically weighted rotors.

In at least one example, the actuator 270 can include a hydraulic cylinder and can also include an integrated LVDT type transducer or other line actuator aligned, coupled, or in contact with the coupling shaft 260. Further, a bearing, such as a thrust bearing 280, can be positioned between the coupling shaft 260 and the actuator 270 to isolate the actuator 270 from the rotation of the coupling shaft 260 while still allowing the actuator 270 to move the coupling shaft 260 about the axis 225A.

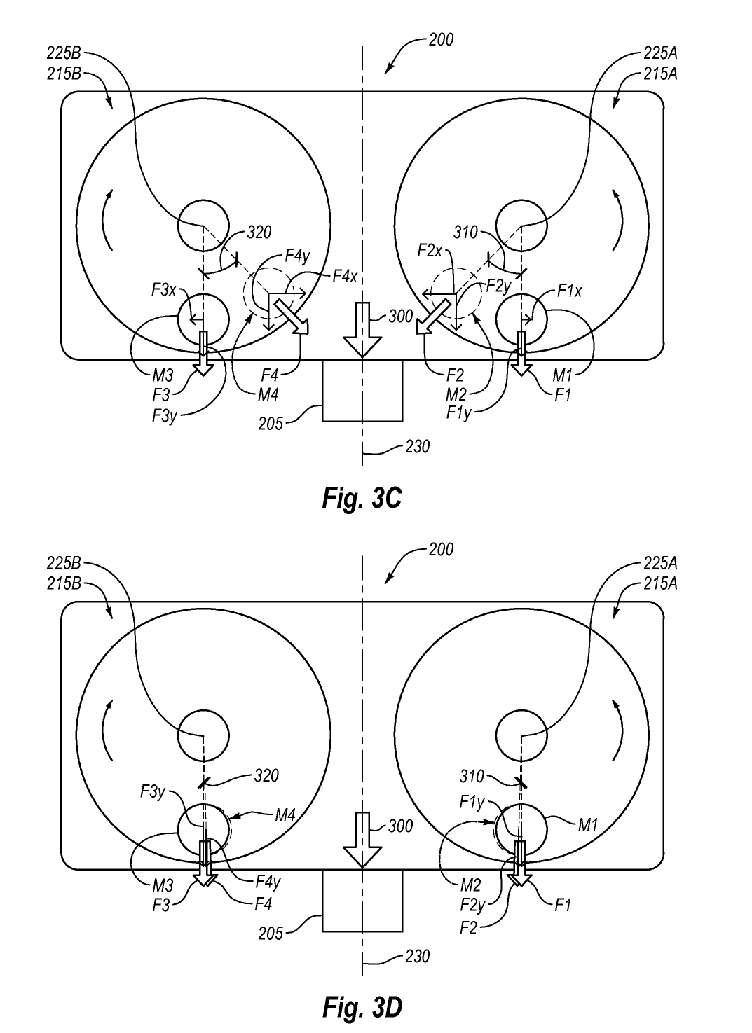

As will be described in more detail with reference to FIGS. 3A and 3D, the angular separation between the first eccentric weight M1 and the second eccentric weight M2 can be changed to vary the force generated by rotation of the oscillator assembly 215A as a whole. As previously introduced, the first and second eccentrically weighted rotors 250, 255 both rotate about the common axis 225A. Accordingly, the angular position of the first eccentric weight M1 and the second eccentric weight M2 can both be described with reference to the common axis, which appears as a single point in FIGS. 3A-3D. The axial position of the helical portion 260B (FIG. 2D) along the axis 225A relative to the second eccentrically weighted rotor 255 (which is into and out of the page in FIGS. 3A-3D) determines the angular separation between the first and second eccentric weighs M1 and M2 as described above.

As shown in FIGS. 3A-3D, the second eccentrically weighted-rotor assembly 215B includes eccentric weights M3 and M4. The first rotor assembly 215A rotates about the axis 225A while the second rotor assembly 215B rotates about the axis 225B. Oscillation forces generated by rotation of the first and second eccentrically weighted-rotor assemblies 215A, 215B, represented collectively as arrows 300, act parallel to a drive shaft axis 230 associated with the drive shaft 205 while transverse forces act perpendicular to the drive shaft axis 230. In the illustrated example, the drive shaft axis 230 is positioned between the axes 225A, 225B. It will be appreciated that in other examples, the axes 225A, 225B can be positioned at any desired position and/or orientation relative to the drive shaft axis 230.

As described above, various angular separations can be established to vary the oscillation force generated by a sonic head. In particular, FIG. 3A illustrates first and second eccentrically weighted-rotor assemblies 215A, 215B rotating in opposite directions in which eccentric weights M1 and M2 are separated by an angular separation 310 of approximately 180 degrees. Similarly, eccentric weights M3 and M4 are separated by a second angular separation 320 of approximately 180.

Rotation of the first and second weighted rotor assemblies 215A, 215B results in a centrifugal forces F1-F4 acting due to the rotation of the eccentric weights M1-M4. Each of the forces F1-F4 can be resolved into an oscillation force acting parallel to the drive shaft axis 230, labeled as F1_{y}-F4_{y} respectively, and transverse forces acting perpendicular to the drive shaft axis 230, labeled as F1ₓ-F4ₓ. In at least one example, the rotation of eccentric weight M1 can be coordinated with M2 such that transverse forces F1ₓ and F2ₓ cancel out transverse forces F3ₓ and F4ₓ while the oscillation forces F1_{y}-F4_{y} act in concert. As will be described in more detail below, the angular separations 310, 320 can be selected to vary the oscillation forces between a minimum, which may be near zero, and a maximum. Exemplary positions will be described in more detail below.

In the example illustrated in FIG. 3A, centrifugal forces F1-F4 generated by rotation of the eccentric weights M1-M4 are cancelled by an opposing eccentric weight, resulting in no force transmission. In particular, in all instances F1 cancels F3ₓ while F2ₓ cancels F4ₓ. With the angular separations 310, 320 shown established, F1_{y} is equal in magnitude to F2_{y}, but F1_{y} acts in the opposite direction than F2_{y}. Similarly, F3_{y} cancels F4_{y}. Accordingly, in the example shown in FIG. 3A no forces are transmitted to the shaft 205.

FIG. 3B illustrates an example in which the angular separation 310 between the first eccentric weight M1 and the second eccentric weight M2 has been selected to be less than 180 degrees but greater than 90 degrees. As a result, within the first eccentrically weighted rotor assembly 215A part of the centrifugal force F1 generated by rotation of the first eccentric weight M1 is offset by the centrifugal force F2 generated by rotation of the second eccentric weight M2.

More specifically, a portion of F1_{y} is countered by F2_{y}. As shown in FIG. 3B, the second angular separation 320 between third eccentric weight M3 and the fourth eccentric weight M4 can be the same as the first angular separation 310. As a result, a portion of F3_{y} is countered by F4_{y}. As previously introduced, in all instances the rotation of the second eccentrically weighted rotor assembly 215B can be synchronized with the first eccentrically weighted rotor assembly 215A such that F1 is countered by F3ₓ while F2ₓ is countered by F4ₓ. It will be appreciated that the synchronization of the rotation and angular orientations of the eccentric weights M1-M4 to minimize forces transverse to the drive shaft axis 230 can be applicable at any angular separations or other conditions for the first and second eccentrically weighted assemblies 215A, 215B. Accordingly, for ease of reference the first angular separation 310 within the first eccentrically weighted assembly 215A will be discussed below, though it will be appreciated that the second eccentrically weighted assembly 215B can have a similar angular separation established therein and can be synchronized as described above.

As shown in FIGS. 3A-3B, if the first angular separation 310 is greater than 90 degrees a portion of F1_{y} is countered by F2_{y} and portion of F3_{y} is countered by F4_{y} For angular separations less than 90 degrees, some portion of the centrifugal force Fl will act in concert with the centrifugal force F2.

FIG. 3C illustrates a situation in which the first angular separation 310 between the first eccentric weight M1 and the second eccentric weight M2 is less than 90 degrees. As a result, F2_{y} cooperates with F1_{y}. Similarly, F4_{y} cooperates with F3_{y}. Accordingly, reducing the first angular separation 310 increases the oscillation forces generated by rotation of the first eccentrically weighted rotor assembly 215A.

As shown in FIG. 3D, the oscillation forces can reach a maximum when the two eccentric weights M1, M2 are aligned, such that the angular separation 310) is approximately zero. Accordingly, the force generated by the sonic head 200 at a given speed can be varied and tuned by varying the angular separation between two eccentric weights on eccentrically weighted rotors. The angular separation in turn can be varied by translating the coupling shaft 260 relative to the second eccentrically weighted rotor 255, as shown in FIGS. 2B and 2E. Any suitable control device can be used to control movement of the coupling shaft.

Referring now to FIGS. 3A-3D, the rotational speed of the first and second eccentrically weighted assemblies 215A, 215B can also be controlled to vary the oscillation forces generated. In general, an increase in rotational speed generates a proportional increase in the frequency of the oscillation forces as well as an increase in the magnitude of those forces. However, as the frequency of the oscillating forces approaches a natural harmonic of the drilling system 100 (FIG. 1), disproportionately large forces can be generated which can cause the sonic drill head 200 to fail. By controlling the rotational speed as well as the angular separation, a drilling system can generate a wide range of oscillation forces while avoiding undesired effects of natural harmonics in a drilling system. In at least one example, a control device may be rigidly attached to the splined shaft 260 while in other examples a control device may not be rigidly attached to the splined shaft 260. Further, a coupling may be provided between a control device and the splined shaft 260 as desired, such as to isolate a control device from vibrational energy.

In at least one example, the first and second oscillator assemblies 215A, 215B can be rotated with desired first and second angular separations 310, 320, such as 180 degrees of angular separation. The rotational speeds of the first and second eccentrically weighted assemblies 215A, 215B can then be increased above that corresponding to a natural harmonic frequency. Thereafter, the angular separations 310, 320 can be decreased as desired to generate increased oscillation forces. Accordingly, the angular separations 310, 320 as well as the rotational speeds can be varied to allow for higher frequency and/or higher oscillation forces while avoiding potentially destructive natural harmonic frequencies. As previously introduced, the angular separations 310, 320 can be varied in any suitable manner.

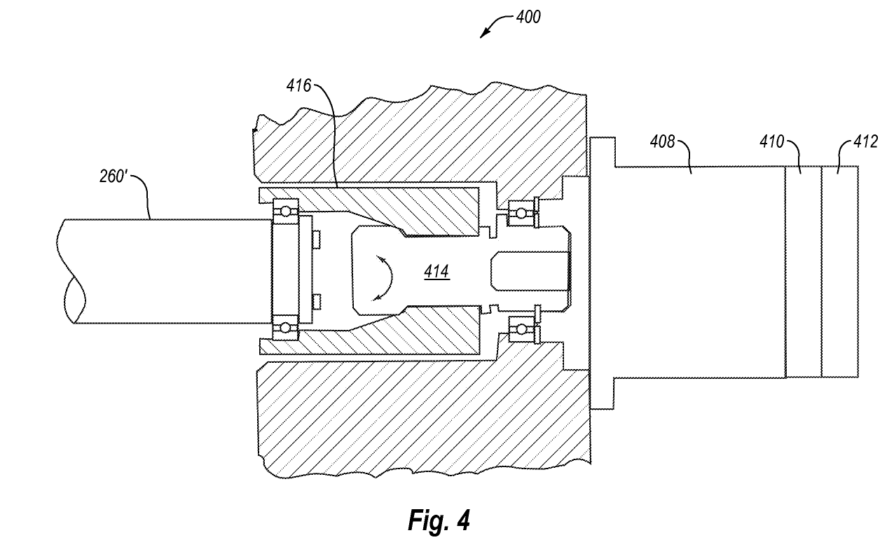

One exemplary control device 400 is shown and described in more detail with reference to FIG. 4. The control device 400 can be configured to position the coupling shaft 260′. In at least one example, the control device 400 includes a stepper motor 408, an encoder 410 and brake 412. A gearbox (not shown) may also be utilized as appropriate or desired. The output shaft of the stepper motor is coupled to a coupling shaft 260′ via a ball screw 414 and nut 416. Further, any device can be used that is capable of converting rotational motion into translating motion.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An oscillator assembly, comprising:
a first eccentrically weighted rotor having a first eccentric weight configured to rotate about an axis;
a second eccentrically weighted rotor having a second eccentric weight configured to rotate about the axis, wherein rotation of the second eccentrically weighted rotor is coupled to rotation of the first eccentrically weighted rotor; and
an actuator operatively associated with the second eccentrically weighted rotor and being configured to vary an angular separation between the first eccentric weight and the second eccentric weight.

2. The oscillator assembly of claim 1, wherein a coupling shaft couples the first eccentrically weight rotor and the second eccentrically weighted rotor, wherein the coupling shaft couples rotation of the first eccentrically weighted rotor to the second eccentrically weighted rotor.

3. The assembly of claim 2, wherein the coupling shaft includes a straight-splined portion and a helically-splined portion.

4. The assembly of claim 3, wherein the straight-splined portion is configured to engage the first eccentrically weighted rotor and the helically-splined portion is configured to engage the second eccentrically weighted rotor, wherein translation of the coupling shaft parallel to the axis changes the angular separation between the first eccentric weight and the second eccentric weight.

5. The assembly of claim 4, wherein movement of the coupling shaft parallel to the axis away from the first eccentrically weighted rotor increases the angular separation between the first eccentric weight and the second eccentric weight.

6. The assembly of claim 5, further comprising a biasing member positioned between the coupling shaft and the first eccentrically weighted rotor, wherein the biasing member is configured to move the coupling shaft toward the second eccentrically weighted rotor.

7. The assembly of claim 6, wherein the actuator is configured to extend to move the coupling shaft toward the first eccentrically weighted rotor.

8. The assembly of claim 1, wherein the first eccentrically weighted rotor is configured to have a rotation shaft coupled thereto.

9. The assembly of claim 1, wherein the actuator is configured to vary the angular separation between the first eccentric weight and the second eccentric weight between 0 degrees and 180 degrees.

10. The assembly of claim 1, wherein the actuator comprises a hydraulic cylinder.

11. The assembly of claim 1, wherein the actuator includes an integrated LVDT type transducer.

12. A method of drilling, comprising:
rotating a first oscillator assembly to generate an oscillating force parallel to a transmission direction, the oscillator assembly including a first eccentrically weighted rotor having a first eccentric weight configured to rotate in a first direction about a first axis and a second eccentrically weighted rotor having a second eccentric weight configured to rotate about the first axis; and
varying the oscillating force by varying the angular separation between the first eccentric weight and the second eccentric weight.

13. The method of claim 12, wherein the first oscillator assembly includes a coupling shaft coupling the first eccentrically weight rotor and the second eccentrically weighted rotor, wherein varying the angular separation includes moving the coupling shaft parallel to the first axis.

14. The method of claim 12, further comprising rotating a second oscillator assembly in a second direction, the second direction being opposite the first direction.

15. The method of claim 14, wherein rotating the second oscillator assembly includes rotating a third eccentrically weighted rotor about a second axis, and the second oscillator assembly further includes a fourth eccentrically weighted rotor having a fourth eccentric weight configured to rotate about the second axis.

16. The method of claim 14, further comprising varying a second angular separation between the third eccentric weight and the fourth eccentric weight.

17. The method of claim 16, wherein varying the first angular separation and the second angular separation includes maintaining the first angular separation and the second angular separation equal.

18. The method of claim 17, wherein rotating the first oscillator assembly in the first direction generates first transverse forces acting transversely to the transmission direction and wherein rotation of the second oscillator assembly in the second direction causes the second oscillator to generate second transverse forces acting transversely to the transmission direction, wherein the first transverse forces cancel the second transverse forces.

19. The method of claim 12, further comprising rotating the first oscillator assembly at an angular separation at a rotational speed, the rotational speed being greater than a rotational speed corresponding to a harmonic frequency, and decreasing the angular separation after the first oscillator is rotating at the rotational speed.

20. The method of claim 19, wherein the angular separation is approximately 180 degrees.

21. A drill head, comprising:
an oscillator having:
a first oscillator assembly including:
a first eccentrically weighted rotor having a first eccentric weight configured to rotate in a first direction about a first axis,
a second eccentrically weighted rotor having a second eccentric weight configured to rotate about the axis, a first coupling shaft coupling the first eccentrically weight rotor assembly and the second eccentrically weighted rotor, and
a first actuator operatively associated with the first coupling shaft being configured to vary an angular separation between the first eccentric weight and the second eccentric weight;
a second oscillator assembly including:
a third eccentrically weighted rotor having a third eccentric weight configured to rotate in a second direction about a second axis, the second direction being opposite the first direction,
a fourth eccentrically weighted rotor having a fourth eccentric weight configured to rotate about the second axis, a second shaft coupling the first eccentrically weight rotor assembly and the second eccentrically weighted rotor, and
a second actuator operatively associated with the shaft being configured to vary a second angular separation between the third eccentric weight and the fourth eccentric weight; and
a drive shaft operative associated with the oscillator, wherein rotation of the first oscillator assembly and the second oscillator assembly transmits an oscillation force to the drive shaft.

22. The drill head of claim 21, wherein the first oscillator assembly and the second oscillator assembly are positioned on opposing sides of the drive shaft.
